(19) United States
(12) Patent Application Publication
(10) Pub. No.: US 2006/0092585 A1
(43) Pub. Date: May 4, 2006

(54) Electrical supply system with arc protection

(76) Inventors: Peter On-Bon Chan, Hong Kong (HK); Franky Wai-Ming Leung, Hong Kong (HK); Malcolm Man-Fat Yung, Hong Kong (HK); Chi-Pui Ho, Hong Kong (HK)

Correspondence Address: JACOBSON HOLMAN PLLC, 400 SEVENTH STREET N.W., SUITE 600, WASHINGTON, DC, 20004, US

(21) Appl. No.: 10/980,832

(22) Filed: Nov. 4, 2004

(51) Int. Cl. H02H 3/00

(52) U.S. Cl. 361/42

(57) ABSTRACT

An electrical power supply system firstly includes a power cable electrically connected to a power source. The power cable has a power line and a first conductor; the first conductor is isolated from the power line and acts as a sensing line. The power cable also has a second conductor and the second conductor is isolated from the sensing line and acts as a neutral line; the power line, the sensing line and the neutral line are electrically connected to the power source. The system further includes an arc fault circuit interrupter including a sensing circuit in electrical connection with the sensing line for detecting an arc fault and a voltage source being in electrical connection with the sensing line. The voltage of the voltage source is designed to be below the hazardous voltage according to the electrical safety rules.

### BACKGROUND

1. Field of the Invention

The invention relates to electrical supply systems with arc fault detection and/or protection circuits.

2. Background of the Invention

In an electrical system, arcing may occur where the distance between two lines of large voltage difference is small enough. Practically arc fault usually occurs in worn power cables where the high voltage lines have the chances becoming very close to each other. As a result, there may occur a tremendous temperature rise at the point of arcing, which may ignite substances around and cause a fire. Such an arc fault may not be detected by traditional over-current circuit breaker since the arcing current may be well below the magnitude of over-current but sufficient to cause high temperature rise.

Various arc fault detection and/or protection circuits have been proposed. For example, U.S. Pat. No. 4,931,894, assigned to Technology Research Corporation and entitled “Ground Fault Current Interrupter Circuit with Arcing Protection,” discloses an additional metal shield at neutral potential simultaneously enclosing line and neutral conductors that senses the arcing current between the line conductor and the neutral potential metal shield. The arc current as the result of the arc fault passes through an additional winding on the same core of the differential transformer for ground fault detection and interruption (making use of the same transformer core for construction of a current transformer for arc fault interruption). A protection triggering circuit responds to arc current occurring between line conductor and the additional metal shield as controlled by a series of resistor.

U.S. Pat. No. 6,292,337, assigned to Technology Research Corporation and entitled “Electrical system with arc protection,” discloses an additional sensing conductor between line and neutral conductors (all line, neutral and sensing conductors are unshielded), which senses the arc current between the line conductor and the sensing conductor during a positive supply cycle, or between neutral conductor and the sensing conductor during a negative supply cycle. The voltage at the sensing conductor is nearly the same in magnitude as the supply voltage, e.g., within a diode drop difference. A resistor is used to convert the arc current into trigger voltage for activation of the supply interruption circuit. An alternative to use metal shields individually for both line and neutral conductors and the shields simultaneously as a sensing conductor is also disclosed. The arc fault interruption mechanism is similar to that of U.S. Pat. No. 4,931,894, i.e., by making use of same core of the differential transformer for ground fault detection and interruption.

In U.S. Pat. No. 6,198,611 and U.S. Pat. No. 6,229,679, both assigned to Pass & Seymour, Inc. and entitled “Arc fault circuit interrupter without DC supply,” sensing of arc fault is conducted by generating short pulses due to di/dt as the result of each arc. Specifically, an integrator in connection with the sensor sums up energy of pulses generated due to detection of arc that generates voltage. When the voltage exceeds a pre-determined threshold, an interruption circuit is activated to disconnect the power supply. This is an indirect method and requires extra care to prevent mis-triggering of interrupter by devices having large transient switching current.

Nevertheless, it is desirable to enhance the protections to the electrical supply system, especially the power line at hazardous voltage.

### OBJECT OF THE INVENTION

Therefore, it is an object of the present invention to provide an improved electrical supply system with enhanced arc fault protections, or at least provide the public with a useful choice.

### SUMMARY OF THE INVENTION

According to an aspect of the present invention, an electrical supply system firstly includes a power cable electrically connected to a power source. The power cable has a power line and a first conductor; the first conductor is isolated from the power line and acts as a sensing line. The power cable also has a second conductor and the second conductor is isolated from the sensing line and acts as a neutral line; the power line, the sensing line and the neutral line are electrically connected to the power source. The system further includes an arc fault circuit interrupter including a sensing circuit in electrical connection with the sensing line for detecting an arc fault and a voltage source being in electrical connection with the sensing line. The voltage of the voltage source is designed to be below the hazardous voltage according to the electrical safety rules.

According to a second aspect of the present invention, an electrical supply system firstly includes a power cable electrically connected to a power source. The power cable has a power line and a first layer of conductor surrounding the power line; the first layer is isolated from the power line and acts as a sensing line. The power cable also has a second layer of conductor surrounding the sensing line, and the second layer is isolated from the sensing line and acts as a neutral line; the power line, the sensing line and the neutral line are electrically connected to the power source. The system further includes an arc fault circuit interrupter including a sensing circuit in electrical connection with the sensing line for detecting an arc fault.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

FIG. 1 is a block diagram illustrating an exemplary electrical supply system embodiment of the present invention;

FIG. 2 is a cross section view of a power cable used in the system of FIG. 1;

FIG. 3A is a circuit diagram illustrating in detail the system of FIG. 1; and

FIG. 3B is another circuit diagram illustrating in detail an alternative embodiment of the system of FIG. 1.

### DETAILED DESCRIPTION

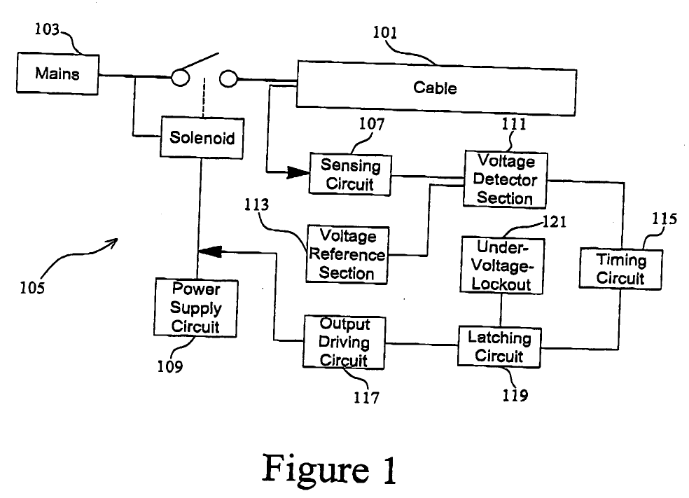

As shown in FIG. 1, an exemplary electrical supply system embodiment 100 of the present invention firstly includes a power cable 101 electrically connected to a power source 103 and an arc fault circuit interrupter generally indicated as 105.

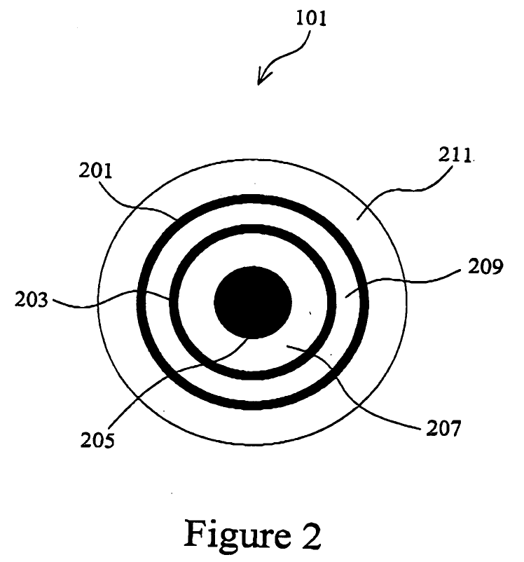

FIG. 2 shows the construction of the cable 101. There are two, preferably, concentric layers of conductors 201, 203 surrounding a centre wire 205. The outermost layer 201 is the neutral wire and the middle layer 203 is the sensing wire. The centre wire 205 is the live, or the power line. Two insulator layers 207, 209 are provided to insulate the sensing wire 203 from the power wire 205 and the neutral wire 201 respectively. Furthermore, an outer shelter 211 surrounding the neutral wire 201 is provided in the cable 101.

Such cable 101 as described in this preferred embodiment is used to replace traditional ones to achieve detection of arc faults in the cable by the arc fault circuit interrupter 105. The power and neutral wires 205, 201 deliver power to appliances from the power source 103 through solenoid-controlled contacts. The sensing wire 203, which is connected to a sensing circuit 107 (See FIG. 1) of the circuit interrupter 105, enables the detection of arc faults that may happen anywhere along the cable 101. When any of the insulating layers 207, 209 of the cable begins to wear out, for example, due to being bent, cut and so on, the middle layer 203 and hence the sensing wire 203, is always the one being made contact to with either the power wire 205 or the neutral wire 201. The sensing circuit 107 can thus safely detect a possible arc fault before arcing occurs between the power wire 205 and the neutral wire 201, which wires actually deliver the power. With this physical construction, the power wire 205 at hazardous voltage is being doubly shielded by the sensing wire 203 and the neutral wire 201. In addition, as damage on cable normally starts from outside, arc fault can be detected before the power wire 205 can be touched.

Furthermore, the sensing wire 203 is connected to a low voltage (not necessarily constant) derived from a voltage reference circuit 113 of the circuit interrupter 105. The low voltage is designed to be below the hazardous voltage that electrical safety rules apply. The supply for the sensing wire 203 provides both electric current sinking and sourcing capabilities, i.e. bi-directional current flow capabilities.

Such an exemplary system offers an extra advantage to users as the power wire 205 at hazardous voltage is firstly protected by a conducting shield 201 at neutral potential, followed by another metal shield 203 at voltage that is safe. By applying a voltage below that which safety rules apply with both current sourcing and sinking capability to the sensing wire 203, both arc current between the power wire 205 and the sensing wire 203, and the are current between the sensing wire 203 and the neutral wire 201, can be detected for the whole supply cycle.

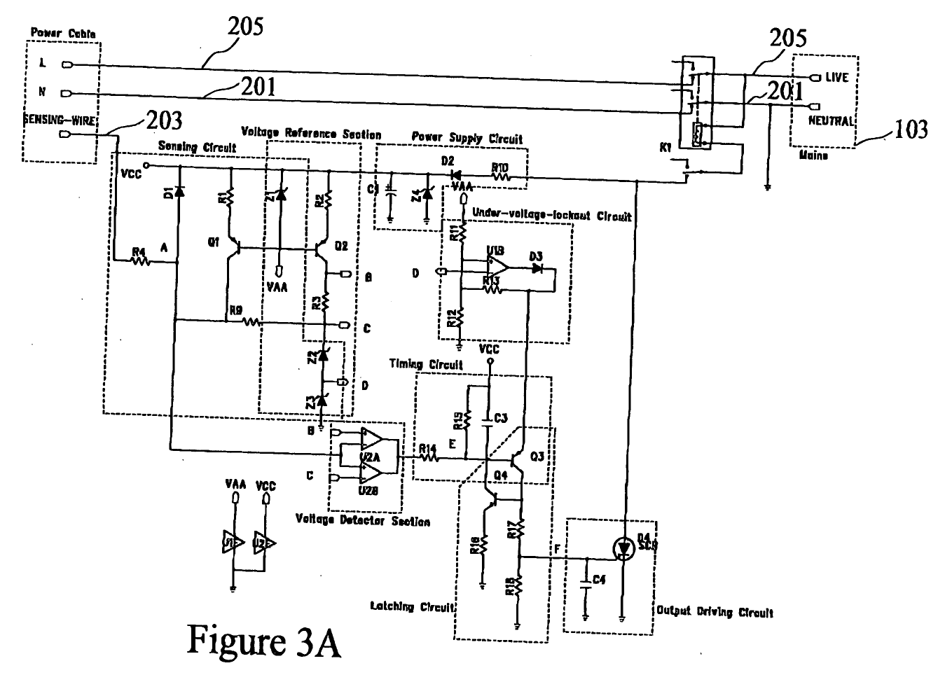

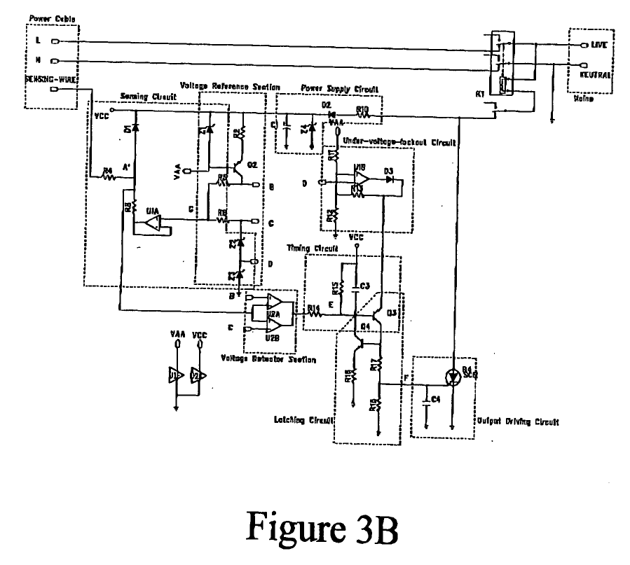

Now referring back to FIG. 1, the circuit interrupter 105 includes the sensing circuit 107 in electrical connection with the cable 101, the power supply circuit 109 and a voltage detector circuit 111. The sensing circuit 107 is connected to the sensing line 203 (see FIG. 2) of the cable so as to ascertain the arc current in an arc fault situation. Specifically, two series resistors (to be discussed in details with reference to FIGS. 3A and 3B) connected between the low voltage source and the sensing wire 203 forms a potential divider circuit. When no arc fault exists, the potential at the centre point (sensing voltage) of the series of resistor will be at the said low voltage. When arc fault occurs, the sensing voltage will deviate from the feeding voltage.

The voltage detector circuit 111, also in electrical connection with a voltage reference circuit 113, detects whether the deviation of the sensing voltage exceeds a reference voltage defined by the voltage reference circuit 113. Further more, the circuit interrupter 105 includes a timing circuit 115 electrically connected to the voltage detector circuit 11, and the timing circuit 115 defines a time constant for filtering accidental triggering of the voltage detector circuit 111. The circuit interrupter 105 also includes an output driving circuit 117 electrically connected between the timing circuit 115 and the power resource 103 for disconnecting the power source 103 with the power line 205 and neutral line 201 when the voltage detector 111 has detected the are fault. A latching circuit 119 is provided in the circuit interrupter 105, electrically connected between the timing circuit 115 and the output driving circuit 117 for turning on the output driving circuit 117 in the arc fault situation and for holding the output driving circuit 117 in an off state if no arc fault has occurred. In addition, the circuit interrupter 105 has an under-voltage-lockout circuit 121, which will be discussed in details below.

As shown in FIG. 3A, the sensing circuit 107 includes resistor R4, diode D1, resistor R1, zener diode Z1, transistor Q1, resistor R9, and zener diodes Z2, Z3. The sensing wire 203 of the power cable 101 is connected to one end of resistor R4. Normally, the sensing wire 203 is open and no current flows through resistor R4. Diode D1 is always reverse biased at this time. The potential at Point A is defined by the current injected from the collector of transistor Q1 into resistor R9, after raised by zener diodes Z2 and Z3. The collector current of transistor Q1 is defined by the voltage across resistor R1 and the magnitude of resistor R1, with the former being set by the voltage of zener diode Z1 minus the base-emitter voltage of transistor Q1. When a hazardous voltage, either positive or negative with respect to the neutral potential, appears at the sensing wire 203, current starts to flow through resistor R4. So long as diode D1 is still reverse biased, this current flows through resistor R9 and hence changes the potential at Point A. This potential deviation will be detected by the voltage detector circuit 111. The potential at Point A is limited to be below VCC, the system circuit operating voltage, via diode D1. Though the dissipating power developed over resistor R4 may be large, it will not cause excessive heat since the application normally trips in tens of milliseconds. The component values are chosen such that the potential deviation at Point A is sufficient to be detected even when the sensing wire is shorted to the neutral potential.

The voltage reference circuit 113 includes zener diode Z1, resistors R2, R3, transistor Q2, and zener diodes Z2, Z3. It supplies three reference voltages for the voltage detector circuit 111, namely, Points B, C and D. The voltage at Point C, together with the voltage developed across resistor R9, contribute to the voltage at Point A, which appears at the sensing wire 203 of the power cable 101 when it is open. Therefore, these voltages are chosen such that the open voltage at the sensing wire 203 is below safety rules. The voltage at Point A is chosen to be at the mid-point between those of Points B and C. It is the voltages at Points B and C that are used by the voltage detector circuit 111 for detecting the potential deviation at Point A when an arc fault occurs. Also, they are chosen such that the potential deviation at Point A is sufficient to be detected (i.e. below voltage at Point C) when the sensing wire 203 is shorted to the neutral potential. A supplementary reference voltage at Point D is supplied for an accompanying fault detector circuit's use such as ground fault circuit interruption.

The voltage detector circuit 111 includes two individual analog voltage comparators U2A, U2B, which form a so-called window comparator such that whenever the voltage at Point A is either above that at Point B or below that at Point C, the comparator output will be active; otherwise it will be inactive. Therefore, when a hazardous voltage appears at the sensing wire 203, either positive or negative with respect to the neutral line 201, the voltage at Point A deviates, either in a positive or negative amount and will activates the comparator output. For simplicity, comparators U2A, U2B are chosen to be of open collector output type so that these outputs can be wired directly together to form the window comparator output without additional components. When active the comparator output becomes shorted to the circuit ground potential. When inactive, it behaves like an open circuit, neither sinking nor sourcing any current.

The timing circuit 115 includes resistors R14, R15, capacitor C3, and transistor Q3. One end of resistor R14 is connected to the output of voltage detector circuit 111. Initially, both transistors Q3 and Q4 are not conducting. When the voltage detector output is inactive, no current flows through resistor R14 or R15. The voltage at Point E is brought to VCC by resistor R15. As the emitter voltage of transistor Q3 is lower than VCC, transistor Q3 is held in the off state. When the voltage detector output becomes active, it shorts to ground potential and sinks current through resistor R14, pulling the voltage at Point E low. Because of the presence of capacitor C3, the voltage at Point E only goes low gradually according to RC charge/discharge phenomenon. Therefore the time constant formed by resistors R14, R15 and capacitor C3 determines the time required to bring the voltage at Point E from VCC to a value low enough to just turn on transistor Q3. The use of the timing circuit 115 is to filter out any spurious triggering of the voltage detector output due to, for example, electrical interference that exists in practical environment.

The latching circuit 119 includes transistors Q3, Q4, and resistors R16, R17 and R18. Initially, transistors Q3, Q4 are turned off by the under-voltage lockout circuit 121 by setting the emitter voltage of transistor Q3 to near ground potential which is insufficient to turn on any base-emitter of transistor Q3 or Q4. Then the emitter voltage of transistor Q3, is raised to near but lower than VCC. As long as the voltage detector output is inactive and since transistor Q4 is turned off, there is no base drive to transistor Q3. Since the only base drive to transistor Q4 is from the collector of transistor Q3, both transistors Q3 and Q4 are thus held, or latched, in the off state. Only when the voltage detector output becomes active, should there be the necessary current to drive the base of transistor W3. When transistor Q3 starts to turn on, its collector outputs current, which drives resistors R17. R18 as well as the base of transistor Q4. Therefore transistor Q4 also starts to sink current through its collector, reinforcing the base drive to transistor Q3. In this aspect, transistors Q3, Q4 drive each other, holding both in the conducting state. Since there is no means to remove the base drive of any of transistors Q3, Q4, the devices are latched in this state. Point F is the output of the latching circuit 119. It is a bi-state output turning on or off the output driving circuit 117. When the latch is in the off state, it sinks current from Point F through R18. When the latch is on, it sources current to Point F through R17.

The output driving circuit 117 includes capacitor C4 and SCR D4, with the gate pin connected to Point F. Normally, Point F is pulled to ground potential by resistor R18 and thus SCR D4 is not conducting. When Point F is pulled by resistor R17 to a voltage high enough to trigger SCR D4, SCR D4 starts to conduct, energizing the solenoid K1 that it drives to trip the power cable 101 from the main power 103. The function of capacitor C4 is to help preventing SCR D4 from mis-triggering by relieving Point F from being influenced by electrical noise

The under-voltage-lockout circuit 121 includes resistors R11, R12, comparator U1B, diode D3 and resistor R13. The circuit 121 is to reset the latching circuit 119 to off state upon powering on. Comparator U1B, being a voltage comparator in this aspect, senses the divided voltage of VAA through resistors R11, R12 at its non-inverting input. On powering up, VCC ramps up is gradually. When VCC is high enough to turn on zener diode Z1, VAA also ramps up accordingly. As VAA ramps up from ground potential, since the inverting input of comparator U1B is already at a higher potential, comparator U1B outputs a voltage near ground potential. It outputs low until VAA ramps up high enough such that the voltage at the non-inverting input of comparator U1B becomes higher than that at its inverting input, at which time comparator U1B outputs high at a voltage near its power supply pin, in this case, VAA. The value of VCC at this time should be higher than the minimum voltage for the whole circuit to operate. Also, the output of comparator U1B pulls its non-inverting input even higher through diode D3 and resistor R13 so that the output of comparator U1B will not change to low again easily until VAA and hence VCC, decays to a sufficiently low value like powering off the whole circuit. Since the emitter of transistor Q3 is driven by the output of comparator U1B through diode D3, the latching circuit 119 is reset to off state at power up and guaranteed to be released to functional state only when VCC is stable for the whole circuit. The presence of diode D3 is to prevent breaking down the base-emitter Junction of transistor Q3 in case the output of comparator U1B momentarily goes low due to electrical noisy condition that usually happens around live mains.

The power supply circuit 109 includes the solenoid K1, resistor R10, diode D2, zener diode Z4 and capacitor C1. Power is drawn from the power wire 205 through solenoid K1, resistor R10 and diode D2 to VCC. Zener diode Z4 is used to limit VCC to a desirable value. Resistor R10 limits the current drawn to a value suitable for the whole circuit to operate. The solenoid K1 helps to reduce the power dissipation of resistor R10 by dropping a certain amount of voltage across ft. Diode D2 rectifies the AC supply into DC voltage, and capacitor C1 helps to smooth the voltage as flat as possible. Since current is drawn through the solenoid, the quiescent current of the whole circuit should be small enough not to mistakenly turn on the solenoid.

An alternative design embodiment is shown in FIG. 3B. It mainly concerns with the sensing circuit. An operational amplifier is used to drive a safe voltage into the sensing wire through resistors R4, R8. In arc fault condition, electric current flows through resistor R4 into resistor R8. Voltage deviation will be developed across resistor R8. Similar to the embodiment of FIG. 3A, this voltage deviation will be sensed by the voltage comparator section to actuate tripping the power circuit. The voltage reference section will provide an extra Point G to the operational amplifier. The voltage of Point G lies midway between Points B and C. The operational amplifier in non-inverting unity gain buffer configuration hence output this voltage at one end of resistor R8. The other end of resistor R8 will be driven by the amount of voltage deviation due to arc current.

What is claimed is:

1. An electrical supply system, comprising
a power cable electrically connected to a power source, including
a power line;
a first conductor wherein the first conductor is isolated from the power line and acts as a sensing line; and
a second conductor wherein the second conductor is isolated from the sensing line and acts as a neutral line; wherein the power line, the sensing line and the neutral line are electrically connected to the power source, and
an are fault circuit interrupter including a sensing circuit in electrical connection with the sensing line for detecting an arc fault and a voltage source being in electrical connection with the sensing line, wherein the voltage of the voltage source is designed to be below the hazardous voltage according to the electrical safety rules.

2. The system of claim 1 wherein the first conductor is a layer substantially surrounding the power line and the second conductor is a layer substantially surrounding the sensing line.

3. The system of claim 2 wherein the voltage source has both electric current sinking and sourcing capabilities.

4. The system of claim 3 wherein the sensing circuit includes a first and a second resistors connected in series between the voltage source and the sensing line for detecting the arc fault.

5. The system of claim 4 wherein the arc fault circuit interrupter includes a voltage detector circuit electrically connected to the sensing circuit for determining whether the arc fault has occurred.

6. The system of claim 5 wherein the voltage detector circuit includes a first and a second voltage comparators for detecting a positive and a negative hazardous voltage at the sensing line respectively.

7. The system of claim 5 wherein the arc fault circuit interrupter further includes a timing circuit electrically connected to the voltage detector circuit, wherein the timing circuit defines a time constant for filtering accidental triggering of the voltage detector circuit.

8. The system of claim 7 wherein the arc fault circuit interrupter includes an output driving circuit electrically connected between the timing circuit and the power resource for disconnecting the power source with the power line and neutral line when the voltage detector has detected the arc fault.

9. The system of claim 8 wherein the arc fault circuit interrupter includes a latching circuit electrically connected between the timing circuit and the output driving circuit for turning on the output driving circuit in the arc fault situation and for holding the output driving circuit in an off state if no arc fault has occurred.

10. The system of claim 3 wherein the arc fault circuit interrupter includes a power supply circuit in electrical connection with the power source for supplying the voltage source.

11. The system of claim 2 wherein the power line, first layer of conductor and second layer of conductor are substantially concentrically aligned.

12. An electrical supply system, comprising
a power cable electrically connected to a power source, including
a power line;
a first layer of conductor surrounding the power line, wherein the first layer is isolated from the power line and acts as a sensing line; and
a second layer of conductor surrounding the sensing line, wherein the second layer is isolated from the sensing line and acts as a neutral line; wherein the power line, the sensing line and the neutral line are electrically connected to the power source, and
an arc fault circuit interrupter including a sensing circuit in electrical connection with the sensing line for detecting an arc fault.

13. The system of claim 12 wherein the arc fault circuit interrupter further includes a voltage source with both electric current sinking and sourcing capabilities, the voltage source being in electrical connection with the sensing line.

14. The system of claim 13 wherein the voltage is designed to be below the minimum voltage according to the electrical safety rules.

15. The system of claim 13 wherein the sensing circuit includes a first and a second resistors connected in series between the voltage source and the sensing line for detecting the arc fault.

16. The system of claim 15 wherein the arc fault circuit interrupter includes a voltage detector circuit electrically connected to the sensing circuit for determining whether the arc fault has occurred.

17. The system of claim 16 wherein the voltage detector circuit includes a first and a second voltage comparators for detecting a positive and a negative hazardous voltage at the sensing line respectively.

18. The system of claim 16 wherein the arc fault circuit interrupter further includes a timing circuit electrically connected to the voltage detector circuit, wherein the timing circuit defines a time constant for filtering accidental triggering of the voltage detector circuit.

19. The system of claim 18 wherein the arc fault circuit interrupter includes an output driving circuit electrically connected between the timing circuit and the power resource for disconnecting the power source with the power line and neutral line when the voltage detector has detected the arc fault.

20. The system of claim 19 wherein the arc fault circuit interrupter includes a latching circuit electrically connected between the timing circuit and the output driving circuit for turning on the output driving circuit in the arc fault situation and for holding the output driving circuit in an off state if no arc fault is has occurred.

21. The system of claim 13 wherein the arc fault circuit interrupter includes a power supply circuit in electrical connection with the power source for supplying the voltage source.

22. The system of claim 12 wherein the power line, first layer of conductor and second layer of conductor are substantially concentrically aligned.
